(19) United States
(12) Patent Application Publication
(10) Pub. No.: US 2023/0274154 A1
(43) Pub. Date: Aug. 31, 2023

(54) Interpretable Anomaly Detection By Generalized Additive Models With Neural Decision Trees

(71) Applicant: Google LLC, Mountain View, CA (US)

(72) Inventors: Jinsung Yoon, San Jose, CA (US); Sercan Omer Arik, San Francisco, CA (US); Madeleine Richards Udell, Ithaca, NY (US); Chun-Hao Chang, Toronto (CA)

(21) Appl. No.: 18/113,267

(22) Filed: Feb. 23, 2023

Related U.S. Application Data
(60) Provisional application No. 63/314,608, filed on Feb. 28, 2022.

(51) Int. Cl. G06N 3/09; G06N 3/088; G06N 3/0895

(52) U.S. Cl. CPC G06N 3/09; G06N 3/088; G06N 3/0895

(57) ABSTRACT

Aspects of the disclosure provide for interpretable anomaly detection using a generalized additive model (GAM) trained using unsupervised and supervised learning techniques. A GAM is adapted to detect anomalies using an anomaly detection partial identification (AD PID) loss function for handling noisy or heterogeneous features in model input. A semi-supervised data interpretable anomaly detection (DIAD) system can generate more accurate results over models trained for anomaly detection using strictly unsupervised techniques. In addition, output from the DIAD system includes explanations, for example as graphs or plots, of relatively important input features that contribute to the model output by different factors, providing interpretable results from which the DIAD system can be improved upon.

### CROSS-REFERENCE TO RELATED APPLICATION

The present application claims the benefit of the filing date of U.S. Patent Application No. 63/314,608, filed on Feb. 28, 2022, the disclosure of which is hereby incorporated herein by reference.

### BACKGROUND

Anomaly detection is the task of distinguishing anomalies from normal data. Anomaly detection is applied in a variety of different fields, such as in manufacturing to detect faults in manufactured products; in financial analysis to monitor financial transactions for potentially fraudulent activity; and in healthcare data analysis to identify diseases or other harmful conditions in a patient. There are multiple settings that anomaly detection is considered.

Machine learning models may be trained to perform anomaly detection. Because anomalies by their nature occur infrequently in real-world data, machine learning models trained for anomaly detection using supervised learning require large amounts of real-world data. Often, labeled data is available in smaller quantities, which can limit the effectiveness of training a model to perform anomaly detection, because the labeled data does not adequately provide different examples of anomalies for which the model is trained to detect.

In addition, models trained on available labeled data for anomaly detection are often not interpretable. Explainable AI (XAI) is a field of artificial intelligence directed to the study of designing models whose behavior or results can be understood by a human being. Model interpretability is a sub-field of XAI in which model input-output relations are analyzed to provide human-understandable rationales, such as statistical correlations between inputs and outputs, or ranking the relative contribution various features in an input to the model have on its output. Models that are not interpretable are referred to as “black-box” models, while models that are interpretable are referred to as “white-box” or “clear-box” models.

A generalized additive model (GAM) is a type of white-box machine learning model. A GAM can be expressed as a link function of feature functions for each feature of an input provided to the GAM. The link function can equal the sum of each feature function, one feature function for each feature present in an input to the GAM. An interpretable GAM (GA²M) also includes feature interaction functions between features j and j′. A feature interaction function is a function that takes as input two different features of an input, j and j′. The link function for a GA²M can be a sum of each feature function and feature interaction function for the features present in an input to the GA²M.

### BRIEF SUMMARY

Aspects of the disclosure provide for interpretable anomaly detection using a generalized additive model (GAM) trained using unsupervised and semi-supervised learning techniques. A GAM is adapted to detect anomalies using an anomaly detection partial identification (AD PID) loss function for handling noisy or heterogeneous features in model input. An unsupervised and semi-supervised data interpretable anomaly detection (DIAD) system can generate more accurate results over models trained for anomaly detection using strictly unsupervised techniques. In addition, output from the DIAD system includes explanations, for example as graphs or plots, of relatively important input features that contribute to the model output by different factors, providing interpretable results from which the DIAD system can be improved upon.

Aspects of the disclosure provide for a system including: one or more processors, the one or more processors configured to: initialize a generalized additive model (GAM), the GAM including one or more neural decision trees including leaves and that are differentiable with respect to weight parameters for the GAM; and train the GAM to receive tabular data as input and to generate an anomaly score and an explanation of the anomaly score, wherein in training the GAM. the one or more processors are configured to: train the GAM using unlabeled data and a loss function measuring the sparsity of data represented by leaves of the one or more neural decision trees; and train the GAM using labeled data.

Aspects of the disclosure provide for a method including: initializing, by one or more processors, a generalized additive model (GAM), the GAM including one or more neural decision trees including leaves and that are differentiable with respect to weight parameters for the GAM; and training, by the one or more processors, the GAM to receive tabular data as input and to generate an anomaly score and an explanation of the anomaly score, wherein in training the GAM. the one or more processors are configured to: training the GAM using unlabeled data and a loss function measuring the sparsity of data represented by leaves of the one or more neural decision trees; and training the GAM using labeled data.

Aspects of the disclosure provide for one or more non-transitory computer-readable storage media storing instructions that are operable, when executed by one or more processors, to cause the one or more processors to perform operations including: initializing, by the one or more processors, a generalized additive model (GAM), the GAM including one or more neural decision trees including leaves and that are differentiable with respect to weight parameters for the GAM; and training, by the one or more processors, the GAM to receive tabular data as input and to generate an anomaly score and an explanation of the anomaly score, wherein in training the GAM. the one or more processors are configured to: training the GAM using unlabeled data and a loss function measuring the sparsity of data represented by leaves of the one or more neural decision trees; and training the GAM using labeled data.

Aspects of the disclosure can include one or more of the features described below. In some examples, aspects of the disclosure provide for all of the features together, in combination.

In training the GAM using the unlabeled data and a loss function measuring the sparsity of data represented by leaves of the one or more neural decision trees, the one or more processors are configured to: estimate the sparsity of data currently represented by leaves of the one or more neural decision trees; and update weight parameter values based on the estimated sparsity.

In estimating the sparsity of data represented by the leaves of the one or more neural decision trees, the one or more processors are configured to: sample a plurality of inputs uniformly from an input space of possible inputs; count the sampled inputs represented by a leaf; and adjust the count according to a predetermined constant.

The sparsity of data at a leaf is based at least partially on the ratio between the volume of the leaf and the percentage of data represented by the leaf.

The one or more processors are further configured to normalize maximum and minimum values of the sparsity for the leaf.

A neural decision tree of the one or more neural decision trees includes a function for splitting the neural decision tree having a range between zero and one, and wherein in training the GAM using the unlabeled data, the one or more processors are configured to perform temperature annealing on the function.

The one or more processors are further configured to: receive one or more inputs for the GAM; and generate, for each of the one or more inputs, a respective anomaly score and respective one or more explanations for the respective anomaly score.

### BRIEF DESCRIPTION OF THE DRAWINGS

FIG. 1 is a flow diagram for training a machine learning model of the DIAD system for anomaly detection using unsupervised and semi-supervised training, according to aspects of the disclosure.

FIG. 2 is a flow diagram of a process for training the DIAD system for interpretable anomaly detection, according to aspects of the disclosure.

FIG. 3 shows example explanations as graphs from a breast cancer detection task performed by a DIAD system trained according to aspects of the disclosure.

FIG. 4 shows explanations before and after fine-tuning a DIAD system on labeled samples, according to aspects of the disclosure.

FIG. 5 is a block diagram of an example environment for implementing the DIAD system.

### DETAILED DESCRIPTION

Aspects of the disclosure are directed to a system for interpretable anomaly detection on tabular data, using a generalized additive model (GAM) trained using both unsupervised and semi-supervised learning techniques. Although examples are provided herein with reference to a GA2M, it is understood that a GAM may also be used, according to aspects of the disclosure.

An unsupervised and semi-supervised data interpretable anomaly detection (DIAD) system can be configured to implement a generalized additive model modified with differentiable tree structures, enabling end-to-end training. The DIAD system is trained using an anomaly detection partial identification (PID) loss function as an objective. The DIAD system can be further fine-tuned with a differentiable loss, for example Area-Under-the-Curve (AUC) loss, with a relatively small amount of labeled training data as compared with models trained using only supervised learning.

The DIAD system can receive, as input, tabular data, for example as rows and columns of data. Each row can correspond to a training example during training, or as an input during inference. Each column can correspond to a feature for the training example or input. A feature is a quantifiable characteristic of the training example or input. For example, the age of a patient may be a feature, and 18 may be a feature value for that feature corresponding to a particular training example or input.

The DIAD system can generate, as output, an anomaly score, and an explanation for the relationship between different features, either as pairwise relationships amongst themselves, or as a relationship between feature values and the outputted anomaly score. The anomaly score is a prediction of the DIAD system as to whether the input is “anomalous” or “normal.”

The accurate classification of data as normal or anomalous depends on the anomaly detection task the DIAD system is trained to perform. For example, in the healthcare space, the DIAD system can be trained to determine whether an input radiological scan presents breast cancer (anomaly) versus other, benign, features (clusters of microcalcification). In another example, the DIAD system can be trained to determine whether data indicative of certain types of network activity corresponds to potential network intrusion by a malicious actor.

In each of these examples and others, the DIAD system as described herein can generate explanations that characterize in some way the relationship between input and output to a GAM trained according to aspects of the disclosure. The explanations can be plots or graphs tracking the relationship between certain features and the predicted score, or relationships, for example positive or negative correlations, between different pairs of features represented in the input or training data.

Providing explanations for model output is a technical challenge, as there is often a trade-off between model explainability or interpretability, and model accuracy. For example, complex models such as deep neural networks may achieve top performance in performing a given task but are not designed to provide additional context in the form of explanations for allowing a human operator to understand what caused the network to generate a certain output given a certain input. Other models, such as linear regression models are more amenable for providing explanations that can be further processed automatically or manually, but do not provide the same levels of performance as the “black box” neural networks.

Aspects of the disclosure provide for at least the following technical advantages. A DIAD system as described herein can more accurately perform anomaly detection over unsupervised and supervised approaches only, even with comparatively smaller amounts of labeled data than what is typical for training models in anomaly detection. The DIAD system can be trained on both available labeled and unlabeled data, while also being trained for generating model interpretable data.

Besides providing greater transparency to the operation of a model through the generation of interpretable data, such as feature importance, in the context of anomaly detection the DIAD system allows for readily interpretable data for understanding why some results are classified as anomalous over others. This interpretable data can improve how anomalies within an environment are defined, which in turn reduces the rate of false positives or false negatives. In either case, the reduction of incorrect classifications can improve the performance of a system being analyzed for anomalies, at least because fewer computational resources are wasted on false positives, and actual anomalies meriting further attention are more accurately detected and addressed before becoming a larger problem.

The DIAD system can detect anomalies in tabular data that are noisy or contain features that are irrelevant for anomaly detection. Noise or irrelevant features may be caused, for example, by measurement noise, outliers, or inconsistent units used across feature values for different inputs. The DIAD system can also handle heterogeneous features within the same input. Features can be heterogeneous, for example, if the features include a mixture of numerical, Boolean, categorical, and/or ordinal values. Heterogeneous features are more common in tabular data than in image or text data. Further, the DIAD system can scale with increasing feature dimensionality, without performance slow-down or with memory or computational requirements increasing faster than input size.

The performance of the DIAD system, for example measured in model accuracy or in the rate of false positive outputs, can be further improved using limited labeled data often available in most applications. Whereas machine learning models for anomaly detection often require large amounts of training data to capture representative examples of anomalies for detection at inference, the DIAD system by contrast can be boosted in performance with comparatively fewer training examples, such as five different anomalous examples.

The DIAD system can generate interpretable results for verification and analysis. Enabling verification and transparency in how the DIAD system generates outputs from input improves the adoptability of the system in anomaly detection applications, particularly in applications such as healthcare, in which anomaly detection systems are used as a tool for accurate diagnosis by a medical practitioner. The DIAD system also provides interpretable results for tabular data, which is generally harder to visualize over other forms of data, such as image data. Output interpretable data can be provided as graphs, which can be used for updating the decision boundary of the DIAD system in classifying input as anomalous or non-anomalous. In anomaly detection, a decision boundary is a region of the output space dividing output into “anomalous” or “non-anomalous.”

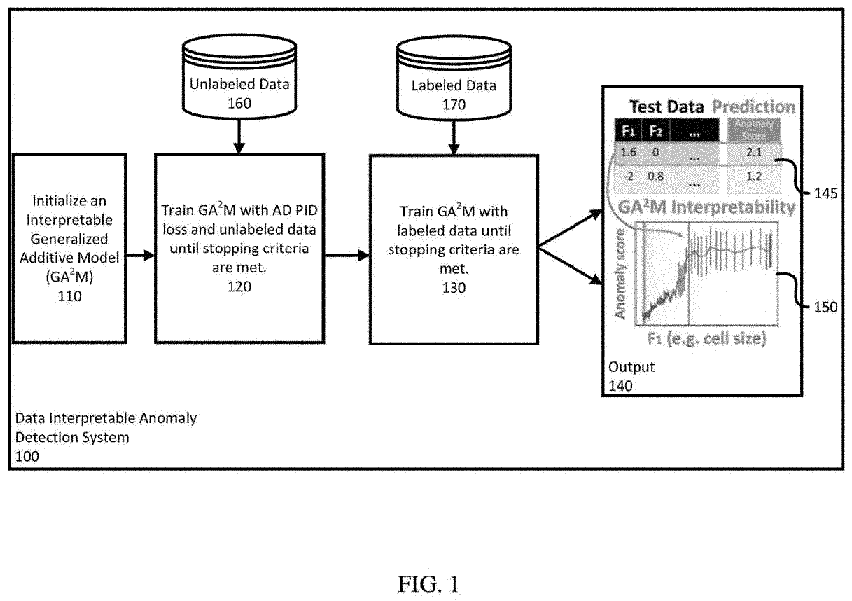

FIG. 1 is a flow diagram for training a machine learning model of the DIAD system for anomaly detection using unsupervised and semi-supervised training, according to aspects of the disclosure. In some examples, the GAM described is trained by a component separate from components such as processors, memory devices, and/or storage devices, at least partially included in the DIAD system. FIG. X illustrates an example computing environment in which the DIAD system is implemented.

The DIAD system 100 can initialize a generalized additive model (GAM) using neural trees to learn feature functions, according to block 110. For example, the DIAD system 100 can initialize the GAM with random weights. The GA²M includes differentiable decision trees. In contrast to decision trees, differentiable decision trees are differentiable with respect to weight parameters for the GA²M. Feature functions in a GAM or GA²M model interactions between pairs of features present in model input. The output of a feature function can be visualized as a graph, for example, a one-dimensional or two-dimensional plot. In some examples, a GA²M is trained and implemented as part of the DIAD system, according to aspects of the disclosure.

For example, The GA²M or GAM can include multiple layers, with each layer including one or more differentiable trees. In some examples, each differentiable tree can include a number of layers, each layer can include a number of differentiable trees, such as differentiable oblivious decision trees (ODT). In an ODT, each node of the same depth in the tree, for example relative to the root of the ODT, shares the same input features and thresholds for branching to nodes at a higher depth. An ODT of depth C compares C chosen input features to C thresholds and returns one of the 2^{c} possible options. Each threshold splits the tree. Tree outputs from one layer of the GA²M or GAM are fed as input to the next layer of the GA²M or GAM.

The use of differentiable trees in the GAM allows for end-to-end anomaly detection training of the DIAD system 100 in a semi-supervised setting, using additional labeled data after initially training the model with unlabeled data, described presently. The final output of the GAM is the average of all the tree outputs for each layer of the GA²M. An example tree output is provided herein with respect to formula (1) in Appendix A, provided herein.

In some examples, the GAM uses a temperature annealed entmoid function, instead of an indicator function. An entmoid function can be expressed as

$${entmax}_{α} ( \frac{{f}_{i} ( x ) - {b}_{i}}{{τ}_{i}} ) ,$$

where entmaxₐ(·) is the alpha-entmax transformation, fᵢ is a splitting feature, and bᵢ and tᵢ are trainable weight parameters for thresholds and scales, respectively. As shown and described with reference to appendix A, the use of temperature annealing (also referred to as simulated annealing) can improve training the GAM for anomaly detection This is at least because, during initial training, the decision boundary is left rough, before sharpening the boundary later on. Temperature annealing can help to increase the sharpness of the decision boundary during the training process and to improve training stability.

In some examples, instead of an annealed entmoid function, other activation functions whose range is in [0,1] can be used, such as sigmoid or sparse sigmoid functions. The entmoid function can be used for performing a soft binary split for splitting a tree at each level of depth.

To allow for two-way feature interactions, for each tree used in the GAM, in some examples only two logits are used for each tree. The rest of the tree at higher depth can be defined as either

$${F}^{1} or {F}^{2} : {F}^{\vert \frac{c}{2} \vert} c > 2 ,$$

where is me floor function. Trees in between layers of the GAM are also not connected (except in an input-output relationship), to avoid the creation of feature interactions between more than two features. An example differentiable decision tree is described with respect to Algorithm 1 in Appendix A, provided herein.

Using unlabeled data 160, the DIAD system 100 trains the GAM with an anomaly detection partial identification (AD PID) loss until stopping criteria are met, according to block 120. An example training step is described herein and with reference to Algorithm 2 in Appendix A.

The DIAD system 100 can repeat the training step multiple times, until meeting one or more stopping criteria. The stopping criteria can include, for example, a maximum number of training steps and/or, for supervised learning or semi-supervised learning, iterations of backpropagation, gradient descent, and model parameter update. The stopping criteria can additionally or alternatively define a minimum improvement between training steps. For semi-supervised training, an example can be a relative or absolute reduction in the computed error between output predicted by the DIAD system 100 and corresponding ground-truth labels on training data reserved for validation.

For unsupervised learning, an example improvement can be a reduction of the anomaly detection partial identification loss (AD PID) described herein, or another loss function. The reduction can be compared absolutely with the loss at a previous training step or compared to be within a predetermined threshold for determining whether the stopping criteria have been met.

In some examples, the DIAD system 100 can be trained for 1000 epochs with early stopping where a validation error is not improved for 10 epochs. Other stopping criteria can be based on a maximum amount of computing resources allocated for training, for example a total amount of training time exceeded, or total number of processing cycles consumed, after which training is terminated.

The AD PID loss compares the deviation of feature values and identifies “sparse” feature values within a feature space. The goal during training is to learn the effective splitting of the feature space with high versus low sparsity, to train the trees of the GAM to maximize the variance of sparsity across leaves, splitting the space into a high (anomalous) and a low (normal) sparsity region.

As an example, in the context of anomaly detection in healthcare, such as for diagnosis or treatment prediction for treating a patient, one feature can be blood pressure (BP). A BP of 300 may be considered anomalous, as it deviates from most other BP values within a population of patients. It is understood that this example value can vary across different populations. In this example, a BP of 300 is in a “sparse” feature space since few patients have a BP of more than 300.

The sparsity sₗ of a tree leaf l is the ratio between the volume of the leaf Vᵢ and the percentage of data Dᵢ represented by the leaf. An example formulation of sparsity can be: sₗ=Vₗ/Dₗ. The volume of a leaf is the proportion of splits within the respective minimum and respective maximum value for each feature presented in the input. For example, the maximum value of BP may be 400 and the minimum value may be 0. A tree split for a tree may be “BP≥300” and the volume of the tree leaf following that split would be 0.25 in the above example. Higher sparsity is treated as more anomalous.

In some examples, the DIAD system 100 estimates the volume and percentage of data for each leaf in a tree l. The DIAD system 100 can sample random points uniformly in the input space and count the number of random points that end up in each tree leaf. More sample points in a leaf indicate higher volume. To avoid the zero count in the denominator, the DIAD system 100 can apply Laplacian smoothing, which adds a constant 8 to each count. An example constant can be 50-100. To estimate the percentage of data, the DIAD system 100 can count the data ratio in each batch or mini batch from the unlabeled data 160.

The DIAD system 100 sets the response of each leaf as the sparsity calculated or estimated, to reflect the degree of the anomaly. Because sparsity estimation involves randomness, in some examples the response is set as the damped value of sparsity, to stabilize performance of the GAM. An example weight update is shown with respect to Formula 8 in Appendix A.

In some examples, the DIAD system 100 introduces per-tree dropout noise on estimated momentum to make each tree operate on a different subset of samples in a mini-batch. In some examples, the DIAD system 100 restricts each tree to split on p % of features randomly, which has the effect of promoting diverse trees in the GAM.

In some examples, the DIAD system 100 normalizes input and output between trees in the GAM. In some examples, the maximum and minimum values of sparsity for a given leaf are scaled to −1 and 1. An example normalization definition is shown with respect to Formula 9 in Appendix A.

Algorithm 2 in Appendix is an example training step for training the GAM with AD PID loss and unlabeled data.

The DIAD system 100 trains the GAM with labeled data 170 until stopping criteria are met, according to block 130. The stopping criteria can be the same or different as stopping criteria used according to block 120.

The DIAD system 100 can train the GAM using mini-batch, stochastic, or batch gradient descent with backpropagation and weight parameter update. Area Under the Curve (AUC) loss can be used as the loss function, although other loss functions may be used from implementation-to-implementation. In some examples, the DIAD system 100 up-samples positive samples, for example samples correctly labeled as anomalous or normal, to be the same number as negative samples in the mini batch. Upsampling in this context can improve uniform sampling.

The output 140 of the trained GAM includes an anomaly score 145 for input data, as well as explanations 150, such as one or more graphs or other data for interpreting the results of the score 145. Because feature interactions were limited to pairs of features, as described herein, the interpretable data can include, for example graphs charting anomaly scores as a function of different feature values for a given feature. This data can be passed downstream, for either automated or manual processing.

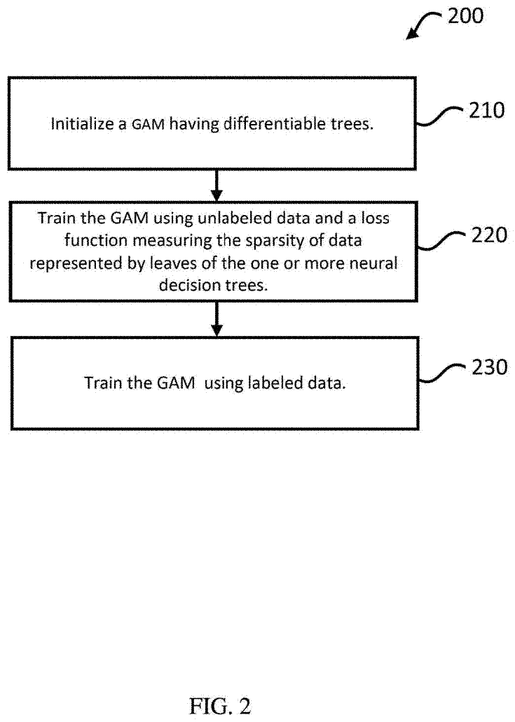

FIG. 2 is a flow diagram of a process 200 for training the DIAD system 100 for interpretable anomaly detection, according to aspects of the disclosure.

The DIAD system 100 initializes a generalized additive model (GAM), the GAM including one or more neural decision trees comprising leaves and that are differentiable with respect to weight parameters for the GAM, according to block 210. In some examples, the DIAD system 100 performs the process 200 using a GA²M instead of a GAM.

The DIAD system 100 trains the GAM to receive tabular data as input and to generate an anomaly score and an explanation of the anomaly score. To train the GAM, the DIAD system 100 trains the GAM using unlabeled data and a loss function measuring the sparsity of data represented by leaves of the one or more neural decision trees, according to block 220.

After training the GAM using the unlabeled data and the loss function, for example the AD PID loss function, the DIAD system 100 trains the GAM using labeled data, according to block 230.

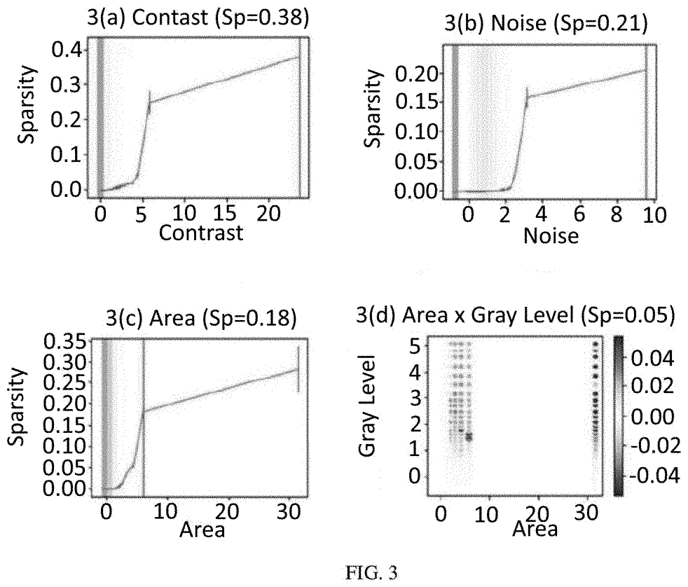

FIG. 3 shows example explanations as graphs 3a-3d from a breast cancer detection task performed by a DIAD system 100 trained according to aspects of the disclosure.

The DIAD system 100 is trained on a dataset of mammograms, with the task of detecting breast cancer (the anomaly) from radiological scans. As part of the task, the DIAD system 100 is trained to differentiate indications of cancer in a scan from other potential sources of bright imaging on a scan, such as clusters of microcalcifications.

Graphs 3a-3d are explanations of the most anomalous sample predicted by the DIAD system 100. Graphs 3a-3c are the top three contributing features for detecting the sample as anomalous, while graph 3d shows a two-way interaction between two features, gray level of the input image, and the area of the anomalous region in the image. The x-axis for graphs 3a-3c are the respective feature values represented (Contrast of the image, Noise in the image, and Area of the anomalous region, respectively), and the y-axis is the model's predicted sparsity (with higher sparsity corresponding to a higher predicted anomaly in images exhibiting the feature at a given value plotted in the graphs).

The DIAD system 100's predicted sparsity is shown in blue, the red backgrounds indicate data density, and the green line indicates the value of the most anomalous sample, with “Sp” as its sparsity. The DIAD system 100 finds this particular sample anomalous because it has high Contrast, Noise, and Area different from values of the majority of other samples.

In graph 3d, the x-axis is the Area, and the y-axis is the gray level, with color indicating the sparsity (blue and red indicating anomalous or normal, respectively)). The green dot in graph 3d is the value of the data that has 0.05 sparsity, for reference.

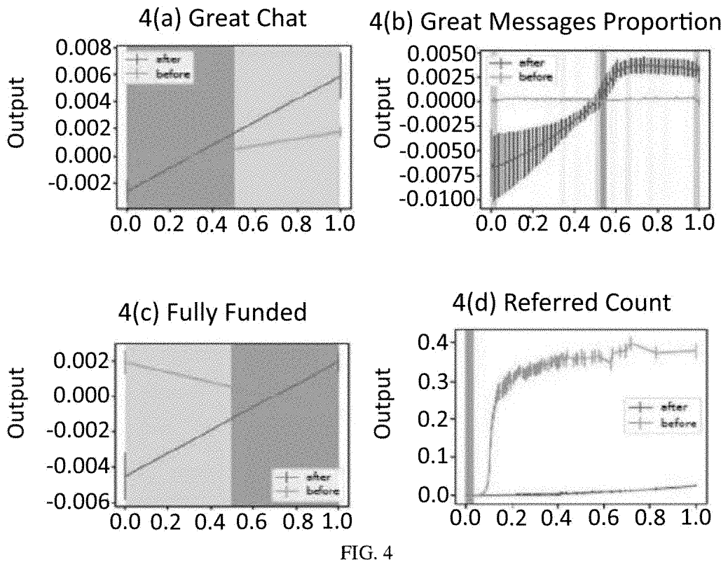

FIG. 4 shows explanations before and after fine-tuning a DIAD system 100 on labeled samples, according to aspects of the disclosure.

In this example, the DIAD system 100 is trained on a dataset of educational proposals at the K-12 level, each with ten features. The DIAD system 100 is tasked to detect anomalies as the top 5% ranked proposals. The four graphs 4a-4d plot various features (“Great Chat,” “Great Messages Proportion,” “Fully Funded,” and “Referred Count”) as a function of the output anomaly score. “Fully Funded” is a feature indicating whether or not the proposal was fully funded. “Great Chat” is a feature indicating the quantity of original messages left by donors for a proposal. “Great Messages Proportion” is a feature indicating the ratio of original to total messages posted to a proposal. The orange curve corresponds to the relationship between the features and the anomaly score before fine-tuning with semi-supervised training according to aspects of the disclosure, while the blue curve corresponds to the relationship between the features and the anomaly score after fine-tuning.

In graphs 4a-4b, two features are shown where the labeled data agrees with the notion of sparsity. After fine-tuning, the magnitude of the relationship between the score and the feature increases. In graphs 4c-4d, the labeled data disagrees with the notion of sparsity, therefore, after fine-tuning, the magnitude of the features changes or decreases.

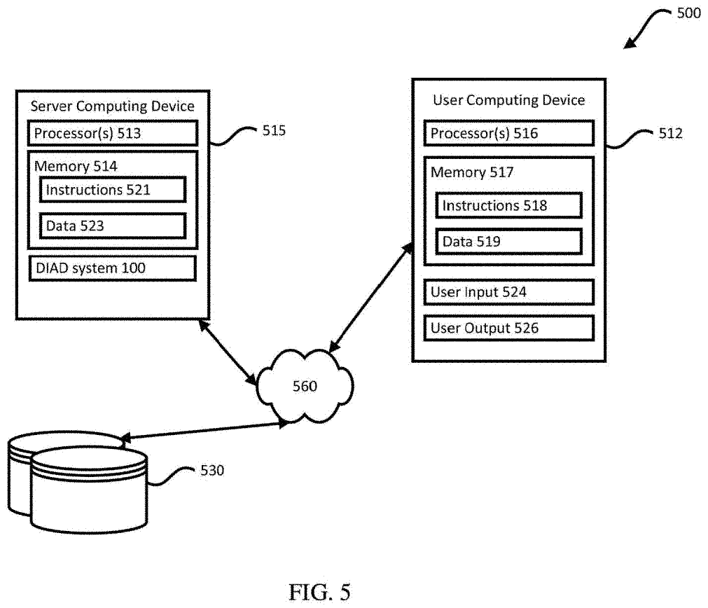

FIG. 5 is a block diagram of an example environment 500 for implementing the DIAD system 100. The system 100 can be implemented on one or more devices having one or more processors in one or more locations, such as in server computing device 515. User computing device 512 and the server computing device 515 can be communicatively coupled to one or more storage devices 530 over a network 560. The storage device(s) 530 can be a combination of volatile and non-volatile memory and can be at the same or different physical locations than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, cause the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing the system 100 consistent with aspects of this disclosure. The system 100 can be executed using the processor(s) 513, and/or using other processors remotely located from the server computing device 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device 515, with one or more processors 516, memory 517, instructions 518, and data 519. The user computing device 512 can also include a user output 526, and a user input 524. The user input 524 can include any appropriate mechanism or technique for receiving input from a user, such as keyboard, mouse, mechanical actuators, soft actuators, touchscreens, microphones, and sensors.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the platform user of the user computing device 512.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The server computing device 515 can be configured to receive requests to process data from the user computing device 512. For example, the environment 500 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 512 may receive and transmit data specifying target computing resources to be allocated for executing a neural network trained to perform a particular neural network task.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, including over various types of Ethernet connection.

Although a single server computing device 515, user computing device 512, and datacenter 550 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, cause the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more processors, cause the one or more processors to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
one or more processors, the one or more processors configured to:
initialize a generalized additive model (GAM), the GAM comprising one or more neural decision trees comprising leaves and that are differentiable with respect to weight parameters for the GAM; and
train the GAM to receive tabular data as input and to generate an anomaly score and an explanation of the anomaly score, wherein in training the GAM. the one or more processors are configured to:
train the GAM using unlabeled data and a loss function measuring the sparsity of data represented by leaves of the one or more neural decision trees; and
train the GAM using labeled data.

2. The system of claim 1, wherein in training the GAM using the unlabeled data and a loss function measuring the sparsity of data represented by leaves of the one or more neural decision trees, the one or more processors are configured to:
estimate the sparsity of data currently represented by leaves of the one or more neural decision trees; and
update weight parameter values based on the estimated sparsity.

3. The system of claim 2, wherein in estimating the sparsity of data represented by the leaves of the one or more neural decision trees, the one or more processors are configured to:
sample a plurality of inputs uniformly from an input space of possible inputs;
count the sampled inputs represented by a leaf; and
adjust the count according to a predetermined constant.

4. The system of claim 2, wherein the sparsity of data at a leaf is based at least partially on the ratio between the volume of the leaf and the percentage of data represented by the leaf.

5. The system of claim 2, wherein the one or more processors are further configured to normalize maximum and minimum values of the sparsity for the leaf.

6. The system of claim 1,
wherein a neural decision tree of the one or more neural decision trees comprises a function for splitting the neural decision tree having a range between zero and one, and
wherein in training the GAM using the unlabeled data, the one or more processors are configured to perform temperature annealing on the function.

7. The system of claim 1, wherein the one or more processors are further configured to:
receive one or more inputs for the GAM; and
generate, for each of the one or more inputs, a respective anomaly score and respective one or more explanations for the respective anomaly score.

8. A method comprising:
initializing, by one or more processors, a generalized additive model (GAM), the GAM comprising one or more neural decision trees comprising leaves and that are differentiable with respect to weight parameters for the GAM; and
training, by the one or more processors, the GAM to receive tabular data as input and to generate an anomaly score and an explanation of the anomaly score, wherein in training the GAM. the one or more processors are configured to:
training the GAM using unlabeled data and a loss function measuring the sparsity of data represented by leaves of the one or more neural decision trees; and
training the GAM using labeled data.

9. The method of claim 8, wherein training the GAM using the unlabeled data and a loss function measuring the sparsity of data represented by leaves of the one or more neural decision trees comprises:
estimating the sparsity of data currently represented by leaves of the one or more neural decision trees; and
updating weight parameter values based on the estimated sparsity.

10. The method of claim 9, wherein estimating the sparsity of data represented by the leaves of the one or more trees comprises:
sampling a plurality of inputs uniformly from an input space of possible inputs;
counting the sampled inputs represented by a leaf; and
adjusting the count according to a predetermined constant.

11. The method of claim 9, wherein the sparsity of data at a leaf is based at least partially on the ratio between the volume of the leaf and the percentage of data represented by the leaf.

12. The method of claim 9, wherein the method further comprises normalizing maximum and minimum values of the sparsity for the leaf.

13. The method of claim 8,
wherein a neural decision tree of the one or more neural decision trees comprises a function for splitting the neural decision tree having a range between zero and one, and
wherein training the GAM using the unlabeled data, comprises performing temperature annealing on the function.

14. The method of claim 8, wherein the method further comprises:
receiving, by one or more processors, one or more inputs for the GAM; and
generating, by the one or more processors, for each of the one or more inputs, a respective anomaly score and respective one or more explanations for the respective anomaly score.

15. One or more non-transitory computer-readable storage media storing instructions that are operable, when executed by one or more processors, to cause the one or more processors to perform operations comprising:
initializing, by the one or more processors, a generalized additive model (GAM), the GAM comprising one or more neural decision trees comprising leaves and that are differentiable with respect to weight parameters for the GAM; and
training, by the one or more processors, the GAM to receive tabular data as input and to generate an anomaly score and an explanation of the anomaly score, wherein in training the GAM. the one or more processors are configured to:
training the GAM using unlabeled data and a loss function measuring the sparsity of data represented by leaves of the one or more neural decision trees; and
training the GAM using labeled data.

16. The one or more storage media of claim 15, wherein training the GAM using the unlabeled data and a loss function measuring the sparsity of data represented by leaves of the one or more neural decision trees comprises:
estimating the sparsity of data currently represented by leaves of the one or more neural decision trees; and
updating weight parameter values based on the estimated sparsity.

17. The one or more storage media of claim 16, wherein estimating the sparsity of data represented by the leaves of the one or more trees comprises:
sampling a plurality of inputs uniformly from an input space of possible inputs;
counting the sampled inputs represented by a leaf; and
adjusting the count according to a predetermined constant.

18. The one or more storage media of claim 16, wherein the sparsity of data at a leaf is based at least partially on the ratio between the volume of the leaf and the percentage of data represented by the leaf.

19. The one or more storage media of claim 16, wherein the operations further comprise normalizing maximum and minimum values of the sparsity for the leaf.

20. The one or more storage media of claim 15, wherein a neural decision tree of the one or more neural decision trees comprises a function for splitting the neural decision tree having a range between zero and one, and
wherein training the GAM using the unlabeled data, comprises performing temperature annealing on the function.
